(19) United States
(12) Patent Application Publication
(10) Pub. No.: US 2004/0069109 A1
(43) Pub. Date: Apr. 15, 2004

(54) Free swinging portable cutting work station

(76) Inventor: Donald G. Sprague, Whitefield, ME (US)

Correspondence Address: STANLEY R. JONES, PATENTS, 49 MIDDLE STREET, HALLOWELL, ME, 04347, US

(21) Appl. No.: 10/458,837

(22) Filed: Jun. 12, 2003

Related U.S. Application Data
(60) Provisional application No. 60/417,940, filed on Oct. 11, 2002.

(51) Int. Cl. B26D 5/08

(52) U.S. Cl. 83/581

(57) ABSTRACT

An improved cutting station having a multi function capability for cutting a wide variety of sheet materials including plywood 4 foot by 8 foot sheets, metal roofing, bulky beams, girders and the like, placed on a semicircular table having centrally mounted thereon a turntable attached to an angularly adjustable cutting guide; and, having versatility in replacing various types of cutting tools on a tool holder supported at a free swinging end of a triangular truss hinged at the apex, and at one end of the cutting guide. A novel slotted collar is used repeatedly throughout the cutting station to reduce the production cost and improve versatility of the apparatus. Equipping the free swinging end of one side of the truss, with a user-selected electrically operated handheld cutting tool, allows easy positioning of the cutting tool for angular, beveled, radial, and plunge cuts.

### RELATED APPLICATIONS

This application is a non-provisional filing of an earlier provisional application by the same title and inventor hereof: namely, Provisional Application No. 60/417,940 filed in Oct. 11, 2002. Said provisional application is hereby incorporated herein as though set forth in full.

### FIELD OF THE INVENTION

This invention relates to cutting tools having a multi function capability for cutting a wide variety of materials including large surface sheets such as 4 foot by 8 foot plywood, metal, ceramic, plastic, bulky beams, girders and the like. More specifically, the field of this invention relates to versatility in replacing various types of cutting tools on a tool holder supported at a free swinging end of a triangular truss hinged both at the apex and the base of a tool guiding support system. The tool guiding support system of this invention allows easy positioning of the cutting tool for angular, beveled, radial, or plunge cuts on a wide variety of materials.

Explanation of Terms

My invention interfaces and operates in conjunction with various saw, router and other cutting tool technologies. Set out below are brief descriptions of certain relevant terms which further the understanding of the invention. These terms provide a basis for a detailed teaching of the improvements of this invention in the relevant arts. Such terms are not intended to replace the claims but rather serve as helpful guides in understanding my novel improvements in these arts.

Triangular Support Truss

A cutting guide in the form of a wide, shallow U channel forms the base of a triangular truss which has a pair of upward legs positioned above the base and forming the cutting tool support system. A rearmost one of the two truss legs is hinged at one cross piece located at the rear of the guide base, and that one leg is formed as a right angle rectangle from rigid tubing in order to provide increased rigidity and stability for that leg. A second front most leg of the truss is hinged at an apex end with the first leg; but, rather than being connected at the other end to the base guide, is not hinged at all. Instead, this second leg includes a free swinging end adapted to hold a cutting tool for user-controlled movements of the cutting tool.

Hinged Articulating Arm

A triangular truss of the invention, as defined above, is referred to as an open triangular truss in that the second leg constitutes a hinged articulating arm which has affixed—at the free end thereof—a cutting tool which is allowed freedom of user-initiated motion. The guide base is hinged at one end to one truss side, and that one truss side is both hinged and spring loaded to the other articulating truss arm. The sides of the truss are hinged together in one plane at an apex of the triangular truss positioned above a material work table for receiving sheet-like materials to be cut.

A cutting tool, as selected by a craftsman, may readily be affixed in place on the free swinging end of the front side of the support truss where such tool may be held and controlled by a user. Thus, the cutting tool becomes freely moveable in one vertical plane, and the spring loading at the rear lower hinge tends to lift the cutting tool upward as the craftsman pulls the tool towards himself. Horizontal movements of the cutting tool allow user-controlled cuts to be made across sheet material located on the work table.

Protractor Base and Cutting Guide

The base guide is rotatable in a horizontal plane about a pin located toward the rear of the work station. A user can swing the free swinging vertical plane for the cutting tool through an adjustable horizontal arc of about 130 degrees as visually presented on a semicircular protractor stand to which the base guide is pinned. Manual locking of the front of the cutting guide at any selected angular marking on the protractor allows angular cuts to run diagonally across, for instance, a four by eight foot sheet of plywood or metal. Moreover, a craftsman may place plunge cuts at various locations in the surface of unwieldy shapes such as wide counter tops. Versatility not suggested by any known art is thus readily available from use of the novel features of this invention.

Turntable Work Station

A material working station of this invention allows a wide variety of sizes and shapes of material to be easily placed on a cutting surface. The cutting guide of this machine is affixed to a circular turntable surface, which surface, in turn, is nested within raised left and right wings mounted above the protractor base. The protractor base carries on its upper surface angular indicator markings, which markings may be visually aligned with a pointer on the end of the guide nearest the user in order to allow the craftsman to select angular cuts across the surface of material which is to be cut. Sacrificial wooden runners are attached as outriggers underneath the ends of these wings. These runners extend from the front to the rear of the station with an upper surface lying within the cutting plane for the work station.

### BACKGROUND-DESCRIPTION OF PRIOR ART

Cutting systems of various types are well known and are in use at lumber supply houses, by contractors and carpenters operating both small and large businesses. With today's building boom, contractors using small trucks continually move from one building site to another, and thus portability of versatile cutting tools is in high demand. It is also known that such craftsmen often interchange a skill type saw equipped with blades for cutting wood with abrasive or diamond ground blades for cutting metals of various thicknesses.

In advanced construction, multilayered and laminated materials assume diverse sizes and types such as foam, cabinet facings, counter tops and the like. Such materials often require on location cuts for custom placement in the particular construction job under way. Additionally, do-it-yourself homeowners likewise require custom cuts of wood and metal either at a supply center or around the home for various projects.

In lumber yards and home supply depots across the country, panel saws are available to custom cut 4 by 8 foot sheets of plywood, paneling and the like on a panel saw provided at the supply center. Such panel saws are bulky, cumbersome units that are normally fixed in place at a cutting station located within the lumber yard. A large panel to be cut is leaned against a holding fixture on a near vertical work table and straight cuts across a panel sheet may be made as desired. Such cuts are almost universally limited to straight cuts either up and down or lengthwise across the panel.

In lumber yards it is common to employ radial arm saws—also fixed in place at a cutting station—to cut various lengths of lumber to size as required by the customer. Such radial arm saws may allow some limited depth adjustments, but again such saws are generally limited to straight cross cuts and are mostly used for custom sizing lengths of lumber. Miter saws are sometimes available at lumber yards and supply centers, but such miter saws are almost universally limited to narrow stock such as molding and the like. A common limitation for such radial or miter saws is stock having no more than a width of eight to ten inches at the most.

A long felt and heretofore unmet need has existed for a versatile cutting tool that is readily portable and can accomplish a large variety of cuts including diagonal and plunge cuts on panels, countertops, metal roofing, and siding amongst other unwieldy shapes. That long felt need is not met by the cutting systems of the prior art as described in the following section.

Patents of Interest

A cursory search on the Internet located some patents and sales literature that has been reviewed by the inventor. The patents include: U.S. Pat. No. 4,181,057—Bassett; U.S. Pat. No. 5,582,088—Harter; U.S. Pat. No. 3,866,496—Payne et al; U.S. Pat. No. 4,555,969—Abt; U.S. Pat. No. 5,421,228*—Fukinuki; U.S. Pat. No. 4,335,512—Martin; U.S. Pat. No. 4,802,399—Olson; and Chubb et al patent No.: U.S. Pat. No. 5,868,054.

In addition to the patents noted above, some sales material pertaining to panel scoring saws offered by a Salesco Company was available on the Internet. Such saws are well known and do not impede upon the novelty of the invention.

Additionally a search was done in the United States Patent Office searching room. The specific areas of search included: Class 83 subclasses 471.3 and 471.2, 486.1 581, 477 and Class 144 sub-classes 154.5. Several patent office search patents of marginal interest are designated below.

| | | |
|---|---|---|
| 5,265,510 * | Nov. 30, 1993 | Hoyer-Ellefsen |
| 4,660,450 | Apr. 28, 1987 | Rafalow |
| 4,494,431 | Jan. 22, 1985 | Niswonger |
| 4,328,728 | May 11, 1982 | Ferdinand et al |
| 4,215,731 | Aug. 5, 1980 | Maynard |
| 4,214,393 | Jul. 29, 1980 | Elhaus |
| 5,287,779 | Feb. 22, 1994 | Metzger, Jr. |
| 5,442,984 | Aug. 22, 1995 | Tate |
| 4,516,453 | May 14, 1985 | Parham, Jr. |
| 4,587,875 * | May 13, 1986 | Deley |
| 4,995,288 | Feb. 26, 1991 | DellaPolla |
| 4,751,865 | Jun. 21, 1988 | Buckalew |
| 4,840,097 | Jun. 20, 1989 | Campbell |
| 4,957,024 * | Sep. 18, 1990 | Albrecht |

### DETAILED DESCRIPTION OF ABOVE-NOTED PATENTS

The patents are grouped into turntable and non-turntable types. Some of the turntable-type references listed above are marked with an asterisk (“*”) and will be discussed below. (To keep this section to a reasonable length the non-turntable-type references are not further discussed since they are of less relevance.)

Many of the reference patents show rigid guide assemblies for straight across cutter movement in one plane.

Perhaps the most pertinent reference of the turntable variety appears to be the Hoyer-Ellefsen patent discussed below.

| | | |
|---|---|---|
| 5,265,510* | Nov. 30, 1993 | Hoyer-Ellefsen |

Hoyer-Ellefsen (“Hoyer”, or '510) has a very confusing description and some areas of the Hoyer drawings do not coincide with the written disclosure. In this '510 Hoyer disclosure, as shown in FIG. 1, for example, two linkage assemblies—one in the vertical (26) and one in the horizontal plane (24)—control and limit the Hoyer saw (20) movement. The vertical assembly 26 includes legs 46 and 48 and these legs are hinged together in the same plane at the apex 50. Such legs are mounted on a rearward extension and mounting platform 14, 18 that is sufficiently deep to allow the saw 20 to move fully behind the work table 12.

A horizontal linkage having pin locations at 40 and 44 is perhaps best shown in Hoyer FIG. 4. These pins are offset from one another and are connected together at Hoyer hinge 32. With the two Hoyer linkages 24, 26 rigidly attached as shown and described, it is not possible to do a plunge cut nor is there any convenient way to lift the Hoyer platform 20 and/or saw 22 away from the cutting location. Instead, Hoyer requires the saw to move behind the work table 12 thus increasing the width of the unit to a large and impractical degree for portable consideration.

Hoyer discloses that a horizontal pin at 40 can include an element 72 as a control for some small vernier type adjusting. It does not, however, allow the saw “upward swing out of the way movement” for handling unwieldy materials during a cutting operation. Moreover, calling 72 a control means does not remove this serious defect of this reference. (See the only mention of elements 70, 72 at Column 4, line 41 and 42 of Hoyer.) In Hoyer the work piece—both the work bench 10 and surface 12 are fixed with platform 18. Platform 18 is said to be optional. In short, properly interpreted, Hoyer's operation mandates that his table swing under a fixed saw blade tract.

| | | |
|---|---|---|
| 4,587,875 * | May 13, 1986 | Deley |
| 4,957,024 * | Sep. 18, 1990 | Albrecht |
| 5,421,228 * | Jun. 6, 1995 | Fukinuki |

One only need look at the structure of these three references to readily see significant distinctions between their disclosure and the novel features of the present invention. In summary, these references, while arguably showing some surface similarity, do not teach or suggest the novel features of the present invention for the versatility and functions achieved by the Sprague cutting system.

### SUMMARY OF THE INVENTION

The invention includes an apparatus and method for cutting large sheet material such as plywood sheets, siding lengths and other large-dimensioned material. A triangular-shaped support truss has an open side which may be manually free swung by a user in order to move a cutting tool up and away from a cutting platform having a flat material resting surface. The cutting platform centrally features a sturdy, yet shallow U channel cutting guide that runs from front to back across an angle marked protractor table in the shape of a semicircle.

The cutting guide, at its rearmost end, is hinged to a pair of tubes formed with upper and lower cross pieces into a rigid, yet pivotable, rectangular support truss. This rearmost end of the cutting guide is connected to a flat horizontal turntable, which turntable is pivotably pinned to the hemispherical table top for angular rotation about a pivot pin. A material resting ledge runs along the rearward edge of a material-holding table, which table includes the rotating turntable nested between a pair of opposed side wings.

Terminating at the outboard ends in the horizontal material resting table is a pair of outrigger runners. The upper edges of these runners also lie in the material resting surface and are selected with a front to back length that will readily receive and support a large 4 by 8 panel, conventional 3.0 or 3.6 doors, two feet wide pre-assembled panels, counter tops with a backsplash in place, vinyl siding, metal roofing, glued assemblies, insulation and laminated board and the like.

In operation, the free swinging tool holder—affixed at the non-hinged end of the pivoting triangular truss—may readily be moved completely free of the material resting table. As such, it allows ample room for the user to place large sheet material such as 4 by 8 plywood sheets, bulky beams, wide girders, structured insulated panels and the like on the material cutting table. Such items may be put in place safely, since the saw (router, or other similar cutting tool) when parked is cleared away from the material resting work surface.

The operational method of this invention allows the craftsman to stand at the foremost front edge of the cutting table with the material rest, saw and saw platform guide in front of the user. All cutting work for a horizontal cutting table starts by the user swinging the cutting tool into place at the front of the U channel guide such that the angular truss is unfolded in a forward direction. In that open position, the cutting tool has moved toward the user where it may be placed for a cutting operation on material to be cut. Tool movements for cutting are manually guided away from the user from the front edge toward the rear edge of the material-holding table.

Central to the work station table is an angularly adjustable circular base connected by bolts, screws or similar connections to the sides of the rear section of the U shaped guide. This guide, at the rearmost end, holds a spring loaded cutting tool support truss and also serves as a cutting guide track positioned above the semicircular angle-setting table.

This circular base is referred to as a turntable since it is set in a matching opening formed by a pair of spaced apart side wings for rotation as an angular adjustable head of the material holding table. The cutting guide extension runs across the desired cutting width—say about two to four feet or so. A forward end of the guide has a pointer above scaled markings etched or otherwise visually present on the upper surface of the curved edge of the semicircular table surface. Such markings facilitate selection by the user of various diagonal cutting angles.

Mounted on the lower surface of the cutting guide, and bearing against the lower surface of the semicircular table, is a cam lock that may be manually set and/or unset as the user selects. This cam lock secures or releases a selected angle for diagonal cuts desired by the user.

Included on the turntable/guide, and fixed for rotation therewith, is an upstanding hinged mounting plate, which plate holds the saw-carrying angular support truss fixture. This truss fixture is in the form of a large triangle having a pair of parallel adjacent tube legs on one side of the triangle hinged at an apex to a downwardly positioned side formed by another tube, with each tube being selected from 2 to 3 inch extruded aluminum pipe about 3 to 5 feet or so in length in order to accommodate wide material cuts. The downwardly pointing truss side, at its free swinging terminating end, is affixed to a tool carrying platform.

This tool platform has an adapter which will receive and allow a user to affix thereto a cutting tool such as a saw, router or the like with the cutting blade extending through a blade opening in the platform. And the platform sits above a wide saw guide. The saw—or other handheld tool is attachable by the user to the platform for sliding movement along the U channel guide as cuts are being made. Both the attached tool and the affixed tool attachment platform may readily be lifted clear of the U guide and the material resting table in order to facilitate material placement against the material positioning ledge. This apparatus allows easy access to the saw, and also allows plunge cuts in wide sheet material such as counter tops, for example.

The turntable is pinned for rotation in line with the center of the material rest on the material table. A cut, when the table is in an elevated horizontal position, starts with the cutting arms in an unfolded position in front of the user with the cutting guide extending across the material table and toward the user. The user manually moves the tool outward and upward away from the pivot pin location for initial sheet placement.

This starting position provides ample stability for a cut—since, once started, the saw itself, as guided by the oversized cylindrical levers of the strut sides—keeps the cut moving along a straight line. The cutting guide runs partially across the turntable and extends radially outward a couple of feet in order to accommodate cuts across large sheet material including 4′ by 8′ pieces of plywood.

### OBJECTS OF THE INVENTION

Several objects and advantages of the invention include allowing diverse types of material to be cut safely and with precision by a portable cutting station that may easily receive handheld electric cutting tools of various kinds.

Still a further object and advantage includes the ability to use all extruded aluminum elements for assembling a light weight, portable cutting station. Separating the cutting station into two pieces easily allows the units to fit in a contractor's pickup truck or van. Each piece weighs about forty-five pounds and thus may easily be moved in or out of a truck or van.

Yet another object of the invention is to employ wide extruded aluminum collars equipped with set screws and threaded holes as a repeatable building block for the cutting station. This collar is multifunctional and serves variously as hinges, joints, spring mounts, junction terminations, bearings, etc. in order to reduce the overall cost and weight of an assembled cutting machine.

Additional objects and advantages of the invention include providing to contractors, a lightweight and portable cutting station at a highly competitive cost, which cutting station may easily be assembled, disassembled and carried in the bed of a van or pickup truck from site to site with minimal set up and take down time.

### DRAWINGS

FIG. 1 is a front perspective view of a cutting station constructed in accordance with the invention showing the free swinging end of a triangular truss system;

FIG. 1A is another front perspective showing the cutting station performing a beveled diagonal cut across a large sheet of material.

FIG. 2, is a rear perspective view of the turntable and triangular cutting guide truss for the station of FIG. 1 with an enlarged inset view showing the detail of a spring loaded cross piece at the bottom of a rectangular truss forming the rear leg of the truss system;

FIG. 3 includes FIG. 3A, FIG. 3B, FIG. 3C, FIG. 3D and FIG. 3E which are respectively simplified side elevations showing various positions of both a saw and a router during a cutting cycle;

FIG. 4 is a front perspective of a tool carrying platform for a right or left handed tool such as an electric skill type saw;

FIG. 5 is an exploded front perspective view depicting the stand, semicircular protractor, wings and runners for the cutting surface;

FIG. 6 is a front perspective view of a router mounted on the tool carrying platform for placing grooves in a large bulky box frame; and

FIG. 7 includes FIGS. 7A, 7B, 7C and 7D which are views showing some selected collar combinations used as repeatable building blocks for the cutting station invention of FIGS. 1 through 6.

### DETAILED DESCRIPTION OF THE DRAWING

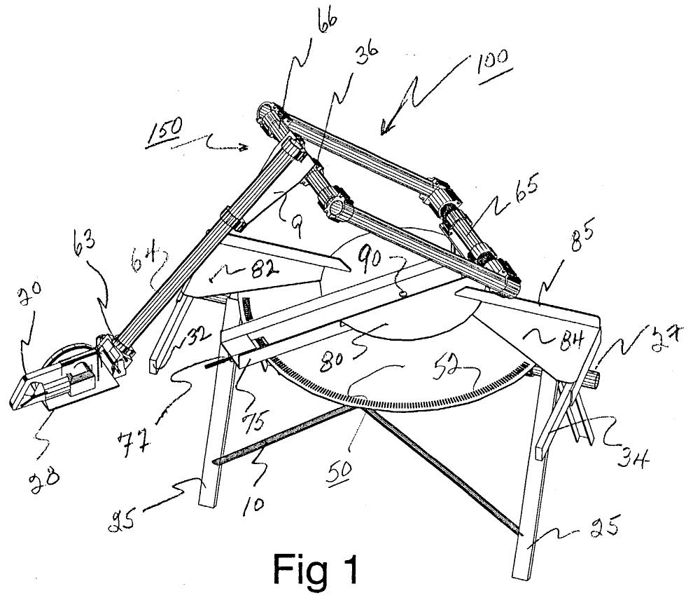

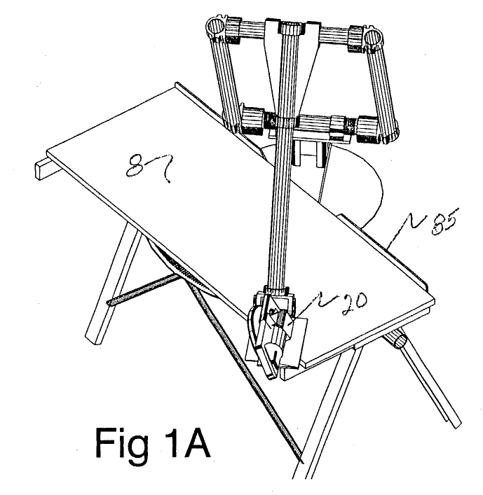

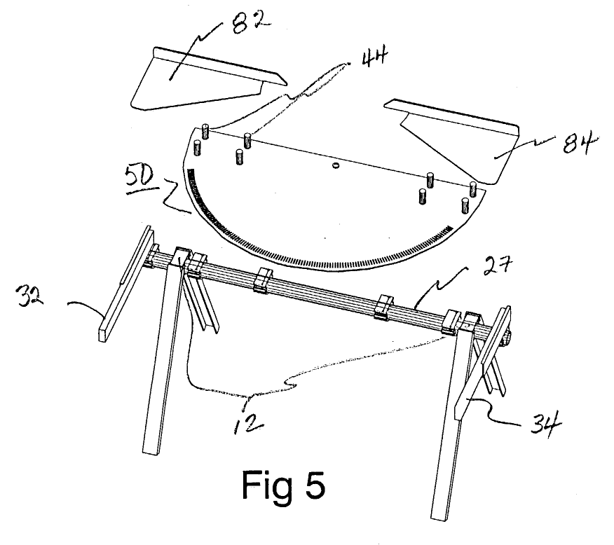

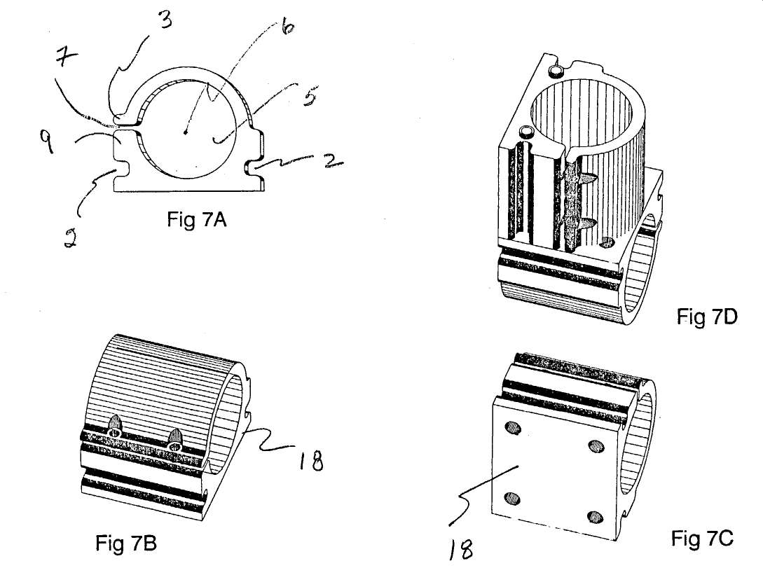

FIG. 1 is a front perspective view of a cutting machine 100 constructed in accordance with my invention. A saw horse type base having a pair of spaced apart legs 25 and an extruded aluminum pipe rail 27 supports a semicircular protractor 50. This pipe rail 27 is rotatable in holding collars and thus may be set at any desired position from horizontal to near vertical as desired for a given cutting station operation. At this point in the description, it is assumed that the pipe rail 27 has been secured for a horizontal table position whereby collars 12 (see FIGS. 5 and 7) are spaced along rail 27 with their flat collar surfaces facing upward to receive and hold the semicircular table 50 in a horizontal position as shown.

FIG. 1A shows another front perspective view of the station of FIG. 1 and depicts a 4 by 8 foot sheet of plywood 8 in place on the material table and against the rear material fence 85. Saw 20 is depicted running both a diagonal and beveled cut across sheet 8. Such a cut simply is not possible with the prior art, and thus FIG. 1A amply demonstrates some of the novel features of my invention.

Returning now to FIG. 1, protractor 50 is in the form of a semicircle, and has provided thereon a series of angular degree markings 52. Resting on protractor 50 is a cutting guide 75 formed as a shallow U channel of extruded aluminum, which guide runs from front to back across the width of the protractor 50. Guide 75 is rearwardly pinned by a pivot pin 90 to protractor 50 and pin 90 allows guide 75 to swivel above table 50 and allow for user-initiated angular cuts across sheet material placed in a cutting position on table 50.

Mounted at the rear of guide 75 and affixed thereto are two semicircular circular segments that are attached to guide 75 and form therewith a turntable surface 80. The front end of the guide 75 includes a cam lock 77 which allows the user to secure a selected angle by manually setting the cam lock 77. Setting such a cam lock, holds the guide 75 in place at a ii selected angular position by frictionally engaging the lower surface of the tool guide 75 against the upper surface of the semicircular table 50. Any well known cam 77 locking action may be used to secure such an angular cutting setting.

Turntable 80 sits between two outrigger wings 82 and 84, which wings each include an upstanding material resting fence 85. The material resting fence 85 runs across the width of the cutting station except for a centrally located space above the turntable, which space protects the fence and accommodates the cutting blade and guide swivel movements during angular cutting operations.

Towards the rear of the cutting guide channel 75 is located a pin 90. This pin 90 may be any suitable bolt that is set in aligned holes through the guide 75 and the semicircular table 50, and pin 90 is fastened with sufficient play that the turntable 80 may rotate angularly around pin 90 as guide 75 swings from left to right as desired by the user.

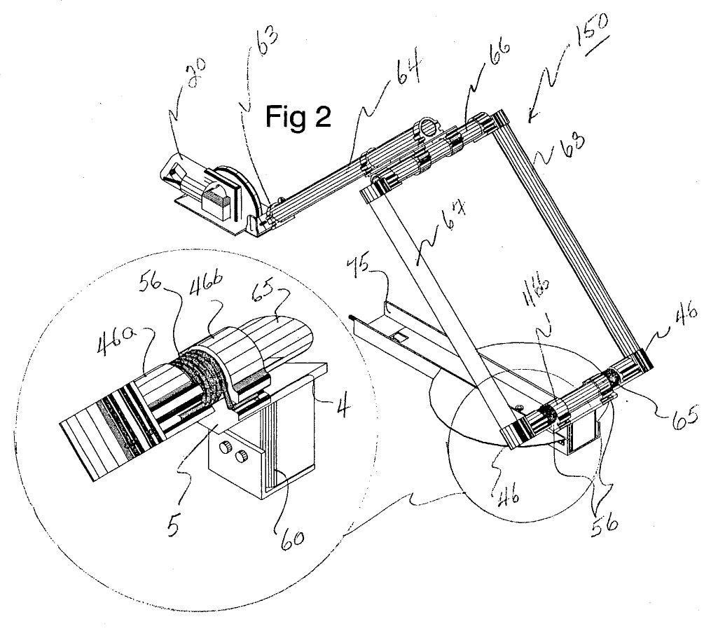

At the rear of the guide 75, as perhaps best shown by the rear inset perspective of FIG. 2, is an upstanding mounting bracket 60. Bracket 60 is inset into the U channel of guide 75 in order to elevate a triangular truss system 150 above the cutting plane. Bracket 60 serves to elevate a cross hinge yoke 65, which yoke may also be formed from extruded aluminum pipes 56 and collars 46. The amount of elevation is in the order of a couple of inches, which elevation is required so that the triangular truss system 150 will swing over and clear the top of material fence 85.

The triangular support truss 150 includes two upper parallel legs 67, 68 attached to cross pieces 65 and 66 by corner collars 46. This rearmost truss side is in the form of a rigid rectangular pipe system which includes the lower cross piece 65, the upper cross piece 66 and parallel side pipes 67 and 68 all joined securely together by a series of interlocked collars 46. Cross piece 65 swivels in place since collars 46b are slightly oversized with respect to the diameter of cross piece 65, allowing the rectangle to be hinged at the rear of cutting guide 75.

Detail within an enlarged insert of FIG. 2 shows that a coil spring 56 surrounds each end of cross piece 65 (only the left hand side is shown in detail.) Each of these coils springs 56 have bent right-angled end pieces that are locked in side by side receiving grooves 4 of a pair of spaced collars 46a and 46b. Collar 46b acts as a rigid bearing since it is bolted or otherwise fixed to the top frame 5 of bracket 60. Collar 46a is fixed to cross piece 65. The other side of the rectangular truss is similarly spring loaded by another pair of collars and another coil spring 56. Thus, bottom cross piece 65 of the rectangular leg is free to angularly rotate within collars 46b.

Returning to FIG. 1, a second front leg 64 of the truss 150 is hinged at an apex end to the upper cross piece 66. A strengthening plate 9 is bolted to side post 64 and this plate 9, in turn, is bolted to a pair of spaced bearing collars 36 surrounding and affixed to cross piece 66.

Cross piece 64—rather than being connected at the other end to the guide 75—has a loose end 63 which end is not hinged to base 75 at all. Instead it is a free swinging end that carries a tool attachment plate 28 for user-controlled movements of a cutting tool, such as, for example, saw 20.

The rigid rectangle 65, 66, 67 and 68—as best shown, perhaps in the rear perspective of FIG. 2—is hinged and spring loaded at the base by a pair of coil springs 56. These coils springs 56 load the triangular truss such that it normally assumes an upright out-of-the-way position. The spring loading 56 also allows the triangular truss 150 to smoothly open as a user pulls on the saw 20 attached at the saw support platform 28.

Indeed, experience has proven that as a user lifts the handle of saw 20 the coil spring pair 56 tends to lift the saw in an upward arc such that it clears the work station material resting table. Thus, a user may easily place unwieldy items such as 4 foot by 8 foot plywood panels, counter tops and the like in place on the material work table against the material fence 85, FIG. 1. User movement of the saw is assisted by the spring loading so that the user may guide the saw in place for any one of a variety of cuts, including plunge cuts.

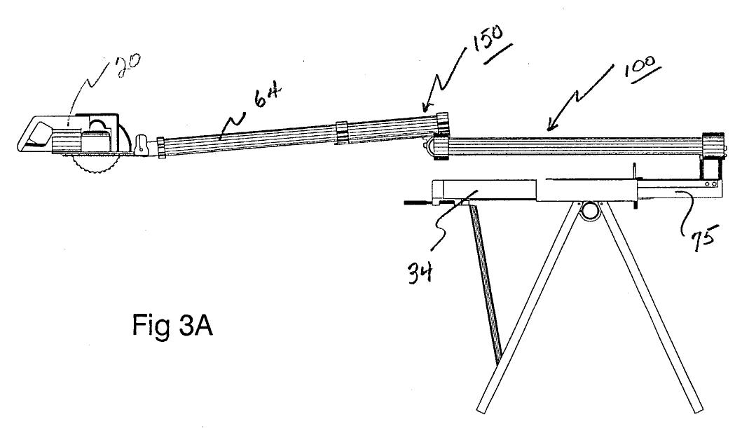

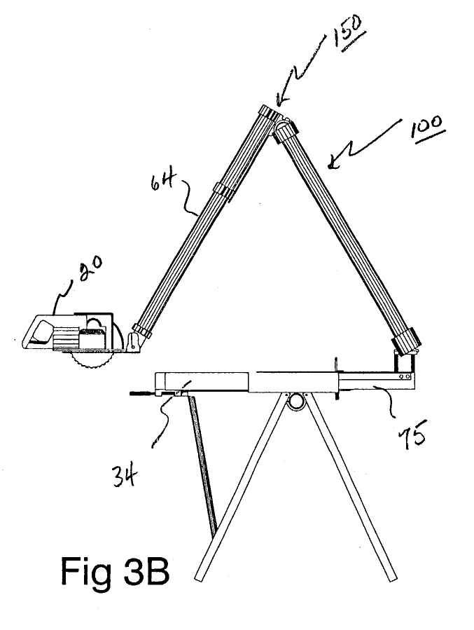

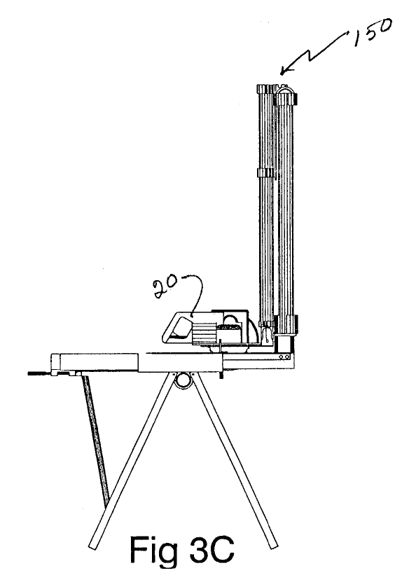

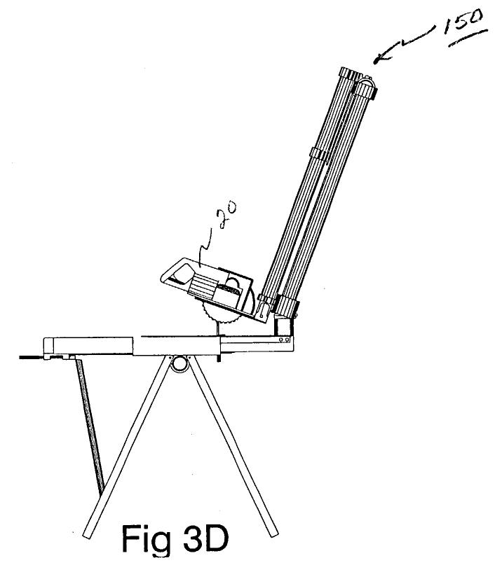

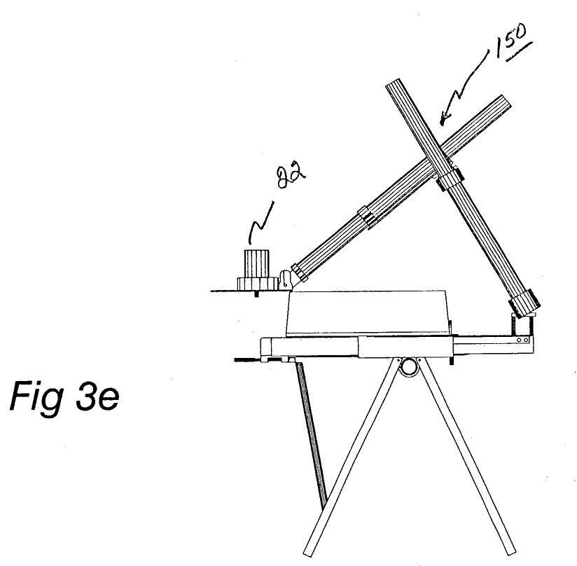

The stored tension in springs 56 at each end of cross piece 65 is selected such that the upright truss structure 150 will tend by itself to spring to and remain in a vertical position. When truss 150 is pulled down by the user, as shown for example in FIG. 3A, the springs 56 are fully wound, and will thus tend to return truss 150 to a vertical position as a cut is being made.

The triangular truss 150 of the invention, as described above, is referred to as an open triangular truss in that one loose side 64 has affixed thereto a cutting tool (e.g., saw 20) which is allowed freedom of user-initiated motion. A cutting tool selected by the craftsman may readily be affixed in place on the free swing end of truss side 64 where it may be held and controlled by a user.

FIG. 3 includes FIG. 3A, FIG. 3B, FIG. 3C, and FIG. 3D which are respectively simplified side views showing various positions of a cutting tool during a cutting cycle. FIG. 3A for example shows the truss fully extended to a maximum reach of several feet. The remaining FIGS. 3B, 3C and 3D show various other tool positions during a cutting cycle. These figures, in view of the accompanying description are believed to be self explanatory, and thus are not believed to require further explanation.

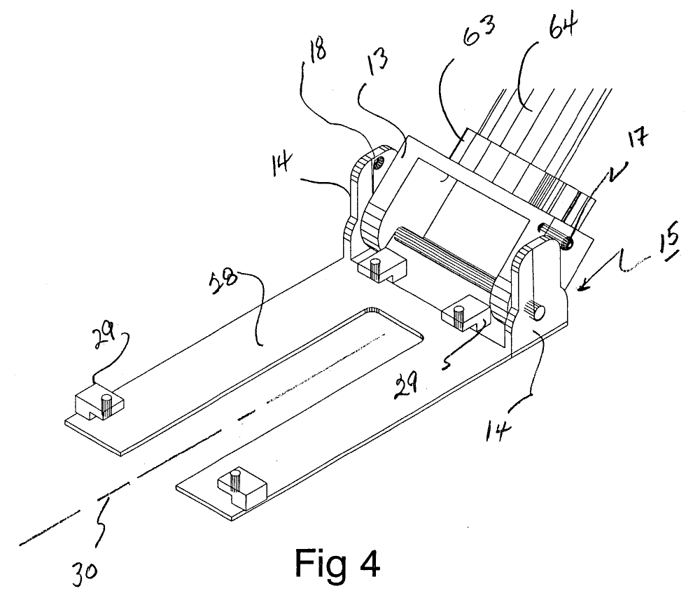

FIG. 4 shows a perspective view of cutting tool attachment plate 28 without any tool in place. The upper surface of plate 28 has a series of affixed clamps 29 that will hold and engage a base plate on most handheld cutting tools. Tightening set screws or other fastening means 29 by a craftsman will allow a selected tool—such as saw 20, of FIG. 2—to be secured in place on attachment plate 28. Left or right hand saws or other tools may readily be attached to plate 28 by fasteners 29 as required. In either case, however, opening 30 provides room for the cutting tool—router bit or saw blade, for example—to extend downwardly from platform 28

For example a right handed saw 20 is depicted in FIGS. 1 and 2 and it would be bolted to the right hand portion of plate 28 by use of right hand fastener 29 while the other fastener is not used. When a left-handed saw is to be employed, such a left handed saw would be attached to the left hand side of plate 28. In either case however, the width of cutting guide 75 allows such tools ample clearance on either side of a center line 30 running along the length of cutting guide 75. Additionally, as jig saws and the like are in use, the depth of the U guide 75 allows up and down blade movement to take place within cutting guide 75 without any damage during a cutting operation. Likewise, beveled cuts provide room for blade tilt within the width of cutting guide 75.

A hinged bracket 15 is located at the rear of plate 28, FIG. 4. This hinge 15 is fastened to the free end 63 of pipe 64. Bracket 15 includes raised dog ears 14 on each side of plate 28, and these ears fit within another mating pair of depending ears 13 attached to free end 63 of truss pipe 64. Both ears 13 are provided with spring loaded ball detents 17. Each detent 17 has a spring loaded ball emerging slightly from a smaller round opening in the ear 13 so that a portion of the ball is exposed beyond the outer surface of ear 13. The exposed ball 17 is sized to mate with opposed and aligned mating openings 18 drilled on the inside of a pair of matched ears 14 extending upwardly from the tool attachment plate 28.

When a user desires to “park” the saw 20, as in FIG. 3D, he simply rotates the platform 28 so that the pair of dog ears 13 and the detent balls and openings of ears 13 and 14 engage each other with sufficient holding force. Once held by the detents, the cutting tool is cleared away from the material cutting plane, and may be moved about as desired by the user. Readying the saw for a cut is simply the reverse operation which is used to disengage the ears 13 and 14 and move the tool out to an extended position for a cut as shown, for example, in FIG. 3A.

When a user is about to make a cut, the tool is pulled forward toward the front of the unit, see FIGS. 3A and 3B described earlier, the spring loading at the lower hinged cross piece 65 tends to lift the cutting tool upward as the craftsman pulls the tool towards himself.

Referring to FIG. 1A, one can see that placing a full sized 4 foot by 8 foot sheet of plywood on the material resting table against fence 85, allows the user to manipulate the free swinging vertical plane for the tool through a horizontal arc of about 130 degrees. In FIG. 1A, the guide has been rotated to the right for a long diagonal cut starting at the corner of the plywood sheet.

Before starting the cut, the user will manually lock the front of the cutting guide 75 at a selected angular marking 52, which setting will allow an angular cut, as shown, to run diagonally across sheet 8, FIG. 1A. Also as shown in FIG. 1A, the saw 20 has been tilted to the left in a well known manner for such hand tools where it is locked in place on its own table. Either a right or left beveled cut may be achieved on material such as a panel 8. Moreover, a craftsman may place plunge cuts at various locations in the surface of unwieldy shapes such as wide counter tops. Versatility not suggested by any known art is thus readily available by the features of this invention.

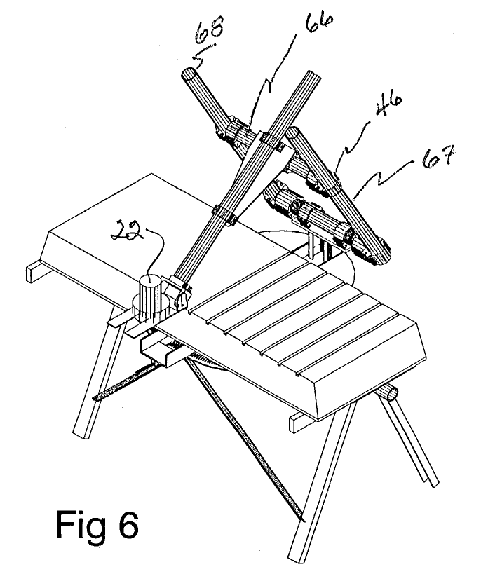

FIG. 6 is a front perspective showing a router 22 positioned on top of a bulky box frame such as divider framework. This view, which is similar to FIG. 1A, shows additional versatility for what is called “fussy” work, wherein a router or saw is used for small precise cuts. In such an instance, the upper cross piece 66 has been lowered downward on parallel legs 67 and 68 and the corner collars 46 have been retightened. The extended upper ends of legs 67 and 68 (above cross piece 66) act as hand guides for the user as cuts are being made. Such additional guides are important, for example, when corrugated surfaces are being cut as the tool seems to float over the waves of the corrugation. Additionally, of course, the lowered position for cross piece 66 moves the router closer to the work and the truss is stiffer for the increased closeness that such “fussy” work requires.

FIG. 5 is an exploded view showing the semi-circular protractor table 50 which includes at its rearward quadrants a series of upstanding studs 44 on each side. These studs 44 sufficiently elevate the side wings 82 and 84 above the table surface 50. Attached to the rail 27 is a pair of spaced sacrificial runners 32 and 34.

They are called sacrificial since, quite obviously, these runners are cut slightly from the top downwardly as the blade making the cut extends slightly through the material being cut. Thus, angular cuts near the extreme of the 130 angular degrees, i.e., the extreme right or left angular swings for the saw cutting guide 75, will expose such runners to cuts by the cutting tool.

If the user so desires, he may convert the novel horizontal cutting station of this invention into a more conventional near vertical panel saw. Such a conversion requires disconnecting the front of table 50 from the vertical supporting braces 10, FIG. 1, and then simply loosening the table rests 12 on rail 27, FIG. 5, and rotating same backwards such that semicircular table 50 tilts rearward to a satisfactory angle to the vertical, which angle is normally about 60 degrees from the horizontal position.

The cutting tool, such as saw 20, is removed from table 28 and by simply increasing the tension in coil springs 56, FIG. 2, the triangular truss 150 is lifted up and out of the way. Again, the truss support swings free allowing ample freedom for the user to load plywood or wide stock on the tilted cutting station. The direction which saw 20 faces on stand 28 must be reversed, and in this mode the user cuts by pushing the saw from a rear parked position toward the front rounded edge of tilted table 50.

FIG. 7 depicts some views of collar combinations used throughout the cutting station of this invention. The collar 4, FIG. 7B is wide, and has two openings 7 which are bored as clearance control holes through rib 3. Rib 3 is in the nature of a radius of collar material and this rib is located above the slot 7 such that the entire collar may be tightened about a pipe 67, 68 when forming the rectangular rear truss of the tool support system of FIG. 2.

Such collars 4 have an increased width which provides higher stability that is desirable in a cutting station of this invention. One need only look at the various views of the invention to determine that extruded collars 4 are used in accomplishing various functions in the assembly and operation of the cutting station. Being extruded parts, their cost is relatively inexpensive, and their multiple redundancies have improved the versatility—while reducing the overall production cost of the cutting station of the invention.

For example, collars 4 are employed as end or corner terminations for some of the pipes such as on the rear rectangular strut of FIG. 2. Other collars are used as bearings 46B, FIG. 2, or as fixed anchor points with flat base surfaces 12, FIG. 5. When used in pairs as shown in FIG. 7D, two collars are fastened together base to end so as to form a moveable corner for adjusting the height of a truss. Such a height adjustment is shown, for example, in FIG. 6 as described earlier.

An extruded collar 4, FIG. 7 has a circular opening 5 along a longitudinal axis 6 centered into and out of the paper on opening 5. Each collar 4 has a flat base 18. Extruded on each side of the collar 4, just above the flat base 18 is a pair of longitudinal grooves 2. Above each groove 2 and parallel thereto is a pair of wide ribs 9. On one side of the collar 4, a slotted opening 7 is cut through the side of the collar 4, which slot 7 cuts through and extends into the circular opening 5. The purpose of slot 7 is to adjust the tension on the collar 4 when used as a bearing or as a tightened anchor point 12, FIG. 5.

While my invention has been described with reference to particular examples of some preferred embodiments, it is my intention to cover all modifications and equivalents within the scope of the following claims. It is therefore requested that the following claims, which define my invention, be given a liberal interpretation commensurate with my contribution to the relevant technology.

What is claimed is:

1. An apparatus for cutting large-dimensioned material, by a handheld tool adapted for attachment to a tool support truss system having a pair of trusses, one front and one back, with each truss having a pair of ends, said apparatus comprising:
a channel cutting guide having a front and rear end, which guide runs from front to back across a cutting surface, and forms at its upper guide edges, a material resting table which holds material to be cut;
said tool support truss system being characterized as triangular-shaped, with said channel cutting guide as a base of the triangle and further having, as the other sides of said triangle, a hinged rear and front truss;
means hinging one end of said cutting guide to one end of a back truss of said tool support truss system;
said front truss not hinged to said channel cutting guide but rather having a free swinging end which may be manually moved by a user to clear the material resting table for material to be cut; and
a cutting tool platform attached to said free swinging end of said front truss for receiving a tool used to cut said material.

2. An apparatus in accordance with claim 1 wherein said rear side of said triangular truss further comprises:
a pair of parallel pipes formed with upper and lower cross pieces into a rigid rectangular support truss which is hinged at the lower and upper ends of said rectangular truss.

3. An apparatus in accordance with claim 1 wherein said material resting table further comprises:
a flat horizontal turntable attached at the rearward end of said guide base;
a material resting ledge running along the rearward edge of the material-holding table and extending over said turntable, which table includes the rotating turntable and a pair of opposed side wings.

4. An apparatus in accordance with claim 1 wherein said material resting table further comprises:
a pair of outrigger runners terminating at the outboard ends of the horizontal material resting table, said runners also having upper edges thereof lying in the material resting surface.

5. An apparatus in accordance with claim 1 wherein said runners of said material resting table further comprises:
a front to back width and a length that will readily receive and support a large 4 by 8 panel, conventional 3.0 or 3.6 doors, two feet wide pre-assembled panels, counter tops with a backsplash in place and the like.

6. An apparatus in accordance with claim 1 wherein said material resting table further comprises:
a protractor semicircular table attached to a rail secured across a saw horse stand;
scaled markings etched or otherwise supplied in the upper surface of the circular edge of the semicircular table; and
locking means associated with said semicircular table such that said guide base may be manually set and or unset as the user selects and secures a selected angle for a diagonal cut with said cutting apparatus.

7. An apparatus in accordance with claim 1 wherein said material resting table further comprises:
a cam lock mounted on the lower surface of the cutting guide and bearing against the lower surface of the semicircular table for locking or unlocking same.

8. An apparatus in accordance with claim 1 wherein said material resting table further comprises:
a cutting tool attachment platform for receiving a tool selected by a user for attachment thereto; and
means securing said saw carrying platform to the downwardly pointing front truss side at its free swinging terminating end.

9. An apparatus in accordance with claim 8 wherein said tool attachment platform further comprises:
a flat surface with a central opening for a saw or other cutting blade together with spaced clamps for securely holding a handheld tool in place on the platform surface with the blade extending through the blade opening.

10. An apparatus in accordance with claim 1 wherein said tool attachment platform further comprises:
means for locking the tool in a parked condition and for releasing same when a cut is to be made

11. A cutting apparatus in accordance with claim 1 wherein said channel cutting-guide, said tool support truss system, and said cutting tool platform further comprises:
all extruded aluminum components.

12. A method for cutting large sheet material comprising the steps of:
placing a channel cutting guide running from front to back as a material resting table for holding material to be cut;
hinging a vertically oriented and top hinged triangular truss system at a rear end of said cutting guide, which truss opens toward the front of the table with a front truss leg that swings upward and away from the cutting table so that material to be cut may be placed thereon; and
attaching a cutting tool to a free swinging end of said front truss leg for receiving a tool used to cut said material.

13. A method in accordance with claim 12 and further comprising the steps of:
forming said cutting guide as a shallow U shaped channel;
attaching a turntable to the rear end of said cutting guide;
pinning the rear section of said cutting guide with a pin located at the center of the turntable section; and
attaching the guide by said pin for angular movement on the upper surface of a raised semicircular table.

14. A method in accordance with claim 12 and further comprising the steps of:
spring loading the truss at the rear end of said cutting guide.

15. A method in accordance with claim 12 and further comprising the steps of:
positioning a material aligning fence along the rear of a work table.

16. A method in accordance with claim 12 and further comprising the steps of:
plunge cutting material by bringing the cutting tool into a cutting position located in the central region of a material to be cut; or bevel cutting the material by tilting the cutting tool on the attachment platform.

17. A pipe collar of a given width having a circular opening centered on a longitudinal axis there through, said collar being of an extruded aluminum material, and comprising, when viewed in cross section:
a flat base surface below said opening together with an integrally curved circular segment of said collar material above and surrounding said opening;
a pair of longitudinal grooves in each surrounding side of said collar material, with said grooves being substantially equal in depth and located immediately above said flat base;
said grooves continuing upwardly into a pair of opposed side ribs spaced equally opposite each other on opposite sides of said collar; and
a slot, above one side rib, cut through said collar material from the outside through to the circular opening.

18. A collar in accordance with claim 17 and further comprising:
a second rib in the nature of a radius of curvature located above said slot.

19. A collar in accordance with claim 17 and further comprising:
transverse openings through said radius of curvature and extending into said rib located below same.

20. A collar in accordance with claim 17 in combination with another collar, said collar combination comprising:
a base of a second collar connected to the end of a first collar with said base of said other first collar aligned with the end of said second collar; and
bolt means joining said collars together to form a corner collar unit.

21. Apparatus for cutting material comprising:
a cutting channel running, relative to a user, from front to back and angularly left or right while serving as a material support for holding material to be cut;
a vertically oriented and top hinged triangular truss system at a rear end of said channel, which truss includes a front truss leg that swings upward and away from the cutting channel so that material to be cut may be placed above said channel by a user; and
a cutting tool attached to said free swinging end of said front truss leg for guiding a cutting tool through said material and into said channel for cutting said material.

22. Apparatus in accordance with claim 21 and further comprising:
said channel is a shallow U shape;
a turntable attached to the rear end of said channel;
means angularly pinning the. rear end of said channel with a pin located at the center of the turntable; and
a material resting surface formed at the upper surface of said turntable.

23. Apparatus in accordance with claim 21 and further comprising:
spring loading means connecting the truss at the rear end of said channel.

24. Apparatus in accordance with claim 21 wherein said truss comprises:
a freedom of upward and downward movement of said cutting tool at said free end leg of said truss for plunge cutting material by allowing the user to move and plunge the cutting tool into a cutting position at the central region of the material to be cut.
